(19) United States
(12) Patent Application Publication
(10) Pub. No.: US 2012/0026271 A1
(43) Pub. Date: Feb. 2, 2012

(54) OPTICAL DISC RECORDING DEVICE AND METHOD FOR DRAWING IMAGE ON OPTICAL DISC

(75) Inventors: Norio HATANAKA, Kyoto (JP); Shinichi Yamada, Osaka (JP); Kazuhiko Miyazaki, Kyoto (JP); Toshihiko Iga, Hyogo (JP); Masato Asano, Osaka (JP)

(73) Assignee: PANASONIC CORPORATION, Osaka (JP)

(21) Appl. No.: 13/267,611

(22) Filed: Oct. 6, 2011

Related U.S. Application Data
(63) Continuation of application No. PCT/JP2010/001640, filed on Mar. 9, 2010.

(30) Foreign Application Priority Data
Apr. 13, 2009 (JP) 2009-096739

(51) Int. Cl. B41J 2/47

(52) U.S. Cl. 347/225

(57) ABSTRACT

The reflected light amount acquiring process acquires the reflected light amount of a laser beam with which a color changeable layer is irradiated from at least one irradiation position included in a predetermined drawing determination area, where the color changeable layer is formed on a label side of an optical disc and changes in color due to heat or light. The operation process compares the reflected light amount acquired from the at least one irradiation position by the reflected light amount acquiring process with a predetermined threshold value to determine whether or not the drawing determination area is suitable for formation of a visible image.

### CROSS-REFERENCE TO RELATED APPLICATION

This is a continuation of PCT International Application PCT/JP2010/001640 filed on Mar. 9, 2010, which claims priority to Japanese Patent Application No. 2009-096739 filed on Apr. 13, 2009. The disclosures of these applications including the specifications, the drawings, and the claims are hereby incorporated by reference in their entirety.

### BACKGROUND

The present disclosure generally relates to techniques of irradiating a color changeable layer which is formed on a label side of an optical disc and changes in color due to heat or light with a laser beam to form a visible image on the label side.

Japanese Patent Publication No. 2006-302503 discloses an optical disc recording device configured to form a visible image, that is, textual information or graphics perceptible by eyes on a data recording side of an optical disc. In this optical disc recording device, writing to the optical disc is disabled before forming the visible image in order to prevent the visible image from being overwritten with other data.

Moreover, in recent years, the technique of irradiating a color changeable layer on a label side of an optical disc with a laser beam to form a visible image on the label side has been proposed.

### SUMMARY

Here, when on a label side on which a visible image has already been formed, another visible image is formed, the already formed visible image may be destroyed by overwriting with the another visible image. Moreover, when a visible image is formed on a scratched label side, the formed visible image overlaps scratches, which may render the image less visible.

In view of the foregoing, the present invention may be advantageous when destruction of a visible image which has already been formed is prevented when a visible image is formed on a label side of an optical disc. The present invention may also be advantageous when formation of a highly visible image on a label side of an optical disc is ensured.

Thus, an example of the present invention is an optical disc drawing process in which a color changeable layer which is formed on a label side of an optical disc and changes in color due to heat or light is irradiated with a laser beam to form a visible image in a visible image drawing area of the label side, the optical disc drawing process including: a reflected light amount acquiring process of acquiring a reflected light amount of the laser beam with which the color changeable layer is irradiated from at least one irradiation position included in a predetermined drawing determination area of the visible image drawing area; and an operation process of comparing the reflected light amount acquired from the at least one irradiation position by the reflected light amount acquiring process with a predetermined threshold value to determine whether or not the drawing determination area is suitable for formation of the visible image, wherein the visible image is not formed in the drawing determination area when the operation process determines that the drawing determination area is unsuitable for the formation of the visible image.

In the optical disc, in an irradiation position unsuitable for formation of a visible image such as an irradiation position in which a visible image has already been formed or an irradiation position in which a scratch has been formed, the reflected light amount of the laser beam may be greater or less than the range of the reflected light amount of an irradiation position suitable for the formation of the visible image. Thus, according to the above example, whether or not a drawing determination area is suitable for formation of a visible image is determined based on a result of comparison between the reflected light amount of the laser beam and a predetermined threshold value. When the drawing determination area is determined to be unsuitable for the formation of the visible image, the visible image is not formed in the drawing determination area. This can prevent destruction of the already formed visible image and formation of a less visible image.

According to the present invention, whether or not a drawing determination area is suitable for formation of a visible image is determined based on a result of comparison between the reflected light amount of the laser beam and a predetermined threshold value, and the visible image is not formed in the drawing determination area when the drawing determination area is determined to be unsuitable for the formation of the visible image, so that destruction of the already formed visible image and formation of a less visible image can be prevented.

### BRIEF DESCRIPTION OF THE DRAWINGS

FIG. 1 is a block diagram illustrating a configuration of an optical disc recording device according to an embodiment of the present invention.

FIG. 2 is a view illustrating a moving range of an optical head in a pickup section.

FIG. 3 is a view illustrating a configuration of a label side of an optical disc.

FIG. 4 is a view illustrating an example of division of the visible image drawing area.

FIG. 5 is a view illustrating an example of a reflected light amount acquired by a reflected light amount acquiring section when a visible image has already been recorded in a visible image drawing area of the optical disc.

FIG. 6 is a view illustrating an example of a reflected light amount acquired by the reflected light amount acquiring section when the visible image drawing area of the optical disc has a defect such as a scratch.

FIG. 7 is a flow chart illustrating operation of the optical disc recording device to form the visible image.

FIG. 8 is a flow chart illustrating a process in S1100 of FIG. 7.

FIG. 9 is a flow chart illustrating a process in S1200 of FIG. 7.

FIG. 10 is a flow chart illustrating a process in S1300 of FIG. 7.

### DETAILED DESCRIPTION

An embodiment of the present invention will be described below with reference to the drawings.

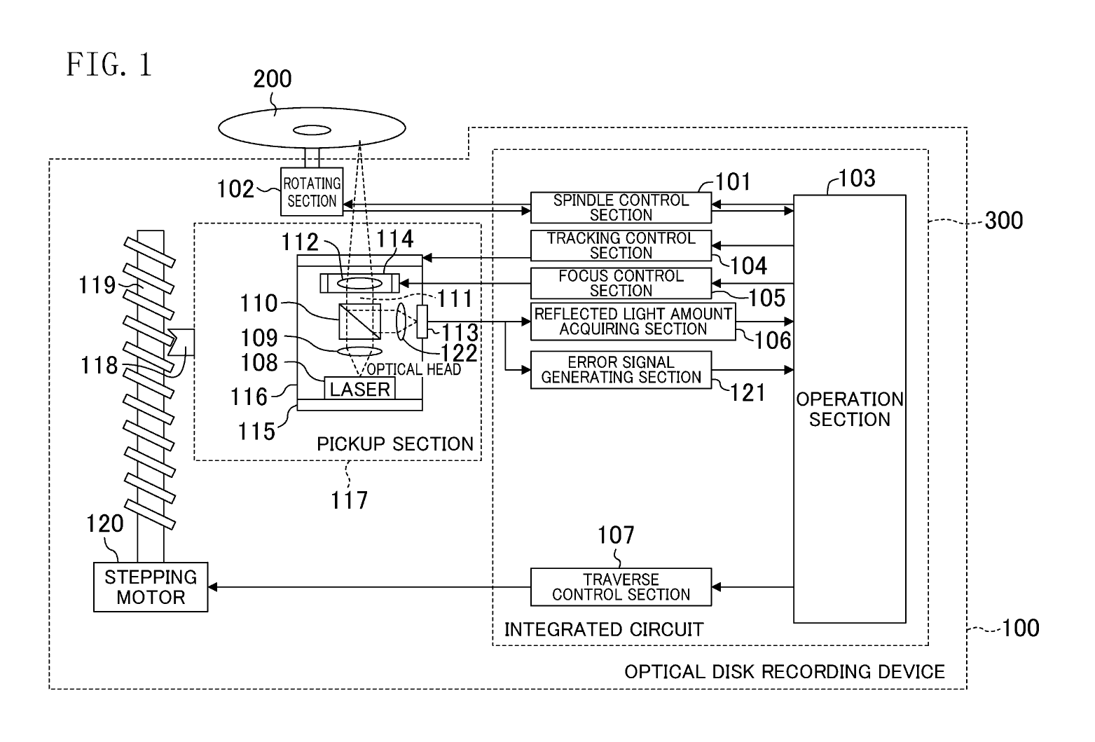

As illustrated in FIG. 1, an optical disc recording device 100 of the embodiment of the present invention includes a rotating section 102, a pickup section 117, a worm gear 119, a stepping motor 120, and an integrated circuit 300, and is configured to write data to an optical disc 200. The integrated circuit 300 may include a plurality of chips, or may include one chip. Moreover, the optical disc recording device 100 is connected to a host personal computer (not shown).

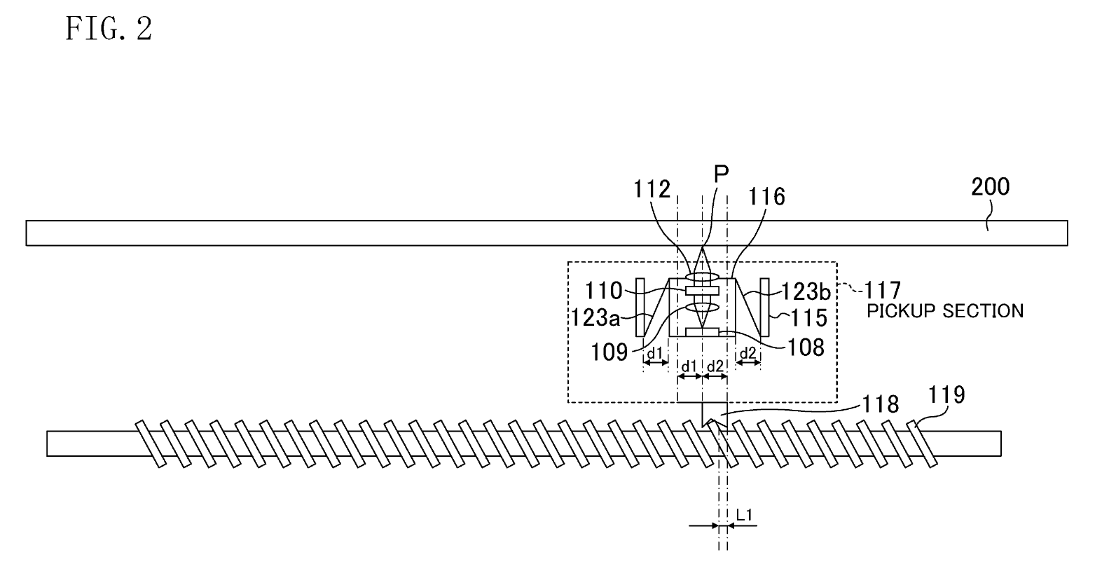

The pickup section 117 includes an optical head 116, a tracking actuator 115, a lug section 118, and springs 123a, 123b (illustrated in FIG. 2).

The optical head 116 includes a laser 108, a coupling lens 109, a polarization beam splitter 110, a photodetector 113, a detection lens 122, a focus actuator 114, a tracking actuator 115, and an objective lens 112. A laser beam 111 generated by the laser 108 passes through the coupling lens 109 by which a parallel ray is provided. Then, the parallel ray passes through the polarization beam splitter 110, and is applied to a surface of the optical disc 200 while being focused on the surface of the optical disc 200 by the objective lens 112. Light reflected on the surface of the optical disc 200 passes through the objective lens 112, the polarization beam splitter 110, and the detection lens 122, and enters the photodetector 113. The photodetector 113 outputs an electric signal based on the amount of the reflected light.

The focus actuator 114 of the optical head 116 includes a focusing coil and a focusing permanent magnet. The objective lens 112 is attached to a movable section of the focus actuator 114. When a voltage is applied to the focusing coil of the focus actuator 114, a current flows over the focusing coil, and the focusing coil receives magnetic force from the focusing permanent magnet. In this way, the objective lens 112 moves in a vertical direction to the surface of the optical disc 200.

The tracking actuator 115 includes a tracking coil and a tracking permanent magnet, where when a voltage is applied to the tracking coil, a current flows over the tracking coil, and the tracking coil receives magnetic force from the tracking permanent magnet. In this way, the optical head 116 horizontally moves in a radial direction relative to the surface of the optical disc 200.

The lug section 118 engages with the worm gear 119 which is fixed to an axis of the stepping motor 120. When the stepping motor 120 rotates, the worm gear 119 also rotates, thereby moving the lug section 118 along teeth of the worm gear 119 in the radial direction of the optical disc 200.

FIG. 2 illustrates a moving range of the optical head 116 in the pickup section 117. In FIG. 2, reference number 200 indicates a cross section of the optical disc. The optical disc 200 has a data recording side on an upper side and a label side on a lower side in FIG. 2. The label side is provided with a color changeable layer which changes in color due to heat or light. The springs 123a, 123b are provided on both edges of the optical head 116 in the radial direction. The spring 123a is located radially inside the spring 123b. In a state in which a tracking control section 104 does not apply a voltage to the tracking coil of the tracking actuator 115, the springs 123a, 123b hold the optical head 116 at a center position between the springs 123a, 123b. Note that in FIG. 2, like reference symbols are used to designate elements having functions similar to those of FIG. 1.

Here, when the expansion widths of the springs 123a, 123b in the radial direction are d1, d2, respectively, application of a voltage to the tracking coil allows the optical head 116 to move over a range from a position located by d1 radially inside the center position between the springs 123a, 123b to a position located by d2 radially outside the center position. That is, the optical head 116 can move over a distance represented by the sum of d1 and d2 with the pickup section 117 being fixed. Thus, an irradiation position P of the laser beam 111 can also move over a distance represented by the sum of d1 and d2 with the pickup section 117 being fixed.

The pickup section 117 moves over a distance L1 in one step by rotating the stepping motor 120 and the worm gear 119.

The integrated circuit 300 includes a spindle control section 101, an operation section 103, a tracking control section 104, a focus control section 105, a reflected light amount acquiring section 106, an error signal generating section 121, and a traverse control section 107.

The spindle control section 101 controls the rotating section 102.

The operation section 103 performs later-described various operations.

The tracking control section 104 controls the tracking actuator 115.

The focus control section 105 controls the focus actuator 114.

Based on the electric signal output from the photodetector 113, the reflected light amount acquiring section 106 acquires the reflected light amount of the laser beam 111 with which the optical disc 200 is irradiated.

Based on the electric signal output from the photodetector 113, the error signal generating section 121 generates a focus error signal and a tracking error signal.

The traverse control section 107 controls the stepping motor 120.

<Spindle Control>

The optical disc recording device 100 having the configuration described above performs spindle control in a way described below. To start rotation of the optical disc 200, the spindle control section 101 outputs, based on a rotation control instruction from the operation section 103, a current to the rotating section 102 to accelerate the rotation. This accelerates the rotation of the optical disc 200. When the rotation is started, the operation section 103 receives a rotation speed signal from the spindle control section 101, and gives an instruction as to a current value to the spindle control section 101 so that the number of rotations is set to a predetermined value. The spindle control section 101 outputs the current value to the rotating section 102. As a result, the optical disc 200 is accelerated, decelerated, or is kept at a certain multiplied speed, so that the optical disc 200 rotates at a predetermined number of rotations.

<Focus Control•Tracking Control>

Focus control is performed by the operation section 103 and the focus control section 105, where the operation section 103 uses the focus error signal generated by the error signal generating section 121 to perform an operation required for the focus control, and the focus control section 105 uses a result of the operation to control the focus actuator 114. The focus control section 105 supplies a current based on the result of the operation to the focusing coil of the focus actuator 114, thereby controlling the focus actuator 114.

Tracking control is performed by the operation section 103 and the tracking control section 104, where the operation section 103 uses the tracking error signal generated by the error signal generating section 121 to perform an operation required for the tracking control, and the tracking control section 104 uses a result of the operation to control the tracking actuator 115. The tracking control section 104 supplies a current based on the result of the operation to the tracking coil of the tracking actuator 115, thereby controlling the tracking actuator 115.

<Formation of Visible Image>

In the optical disc recording device 100, the color changeable layer on the label side of the optical disc 200 is irradiated with the laser beam 111 to form a visible image on the label side.

To form the visible image, a current is supplied to the tracking coil of the tracking actuator 115, so that the optical head 116 moves back and forth by a given width equal to or less than the sum of d1 and d2. During this period, the optical disc 200 is rotating, so that the optical disc 200 is irradiated with the recording laser beam 111 such that the laser beam 111 moves back and forth by the given width and traces a circular arc on the optical disc 200. Thus, continuous irradiation of a continuous arcuate area with the laser beam 111 at a same power allows the color changeable layer to change in color to have a same tone, and an arcuate visible image having a given width equal to or less than the sum of d1 and d2 to be formed. Moreover, controlling a current supplied to the laser 108 can produce light and shade within a continuous arc. The stepping motor 120 is rotated to move the pickup section 117 so that the entirety of the optical disc 200 is irradiated with the laser beam 111 with the optical head 116 moving back and forth by a given width equal to or less than the sum of d1 and d2, which can form the visible image on the entirety of the optical disc 200.

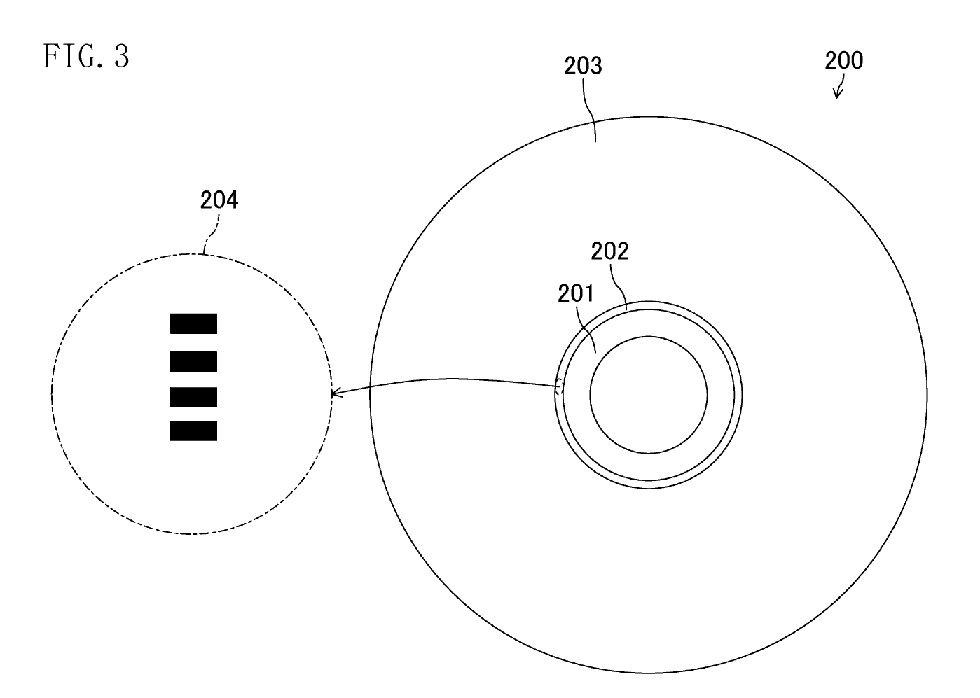

Nun, the configuration of the label side of the optical disc 200 will be described with reference to FIG. 3. The label side of the optical disc 200 includes three areas, that is, an area 201, an area 202, and an area 203.

The area 201 is located at an innermost circumference of the optical disc 200, is not provided with the color changeable layer, and has high reflectivity. In the area 201 (hereinafter referred to as a lead-in area 201), innermost circumference information has been recorded by forming pits and lands into a spiral track. The innermost circumference information is composed of information indicating that a surface storing the innermost circumference information is a label side of a disk supporting visible image drawing, pigment information of the disk 200, and information indicating an optimal value of the laser beam 111.

Note that the area 201 may be provided with the color changeable layer. In this case, an unrecorded portion of the area 201 has the same reflectivity as the areas 202, 203.

The area 202 is provided with the color changeable layer, and can store symbols 204 when irradiated with the laser beam 111.

The area 203 (hereinafter referred to as a visible image drawing area 203) is provided with the color changeable layer, as in the case of the area 202, and is an area in which an image is to be drawn. No track exists in the area 202 and the area 203.

The border between the area 202 and the area 203 is a recording start position in the radial direction when an image is recorded in the optical disc 200.

To form a visible image, the operation section 103 divides the visible image drawing area 203 into a plurality of divided areas, specifies each divided area as an independent drawing determination area, and determines whether or not each divided area (each drawing determination area) is suitable for formation of the visible image. The optical disc recording device 100 does not form the visible image in a divided area (a drawing determination area) which has been determined by the operation section 103 to be unsuitable for the formation of the visible image. The determination is made based on the reflected light amount of the laser beam at a plurality of irradiation positions included in each divided area.

Here, the reflected light amount is acquired while the tracking actuator 115 allows the optical head 116 to move back and forth by the width which is the sum of d1 and d2. For example, the tracking actuator 115 allows the irradiation position P of the laser beam 111 to move back and forth by the width which is the sum of d1 and d2, and the rotation of the stepping motor 120 allows the pickup section 117 to move by the sum of d1 and d2 per rotation. In this way, the reflected light amount of the entirety of the optical disc 200 can be obtained within a short time which is a product of time required for one rotation of the optical disc 200 and a value obtained by dividing the width in a radial direction of the visible image drawing area 203 by the sum of d1 and d2. Note that the reflected light amount may be acquired by allowing the optical head 116 to move back and forth by a width smaller than the sum of d1 and d2.

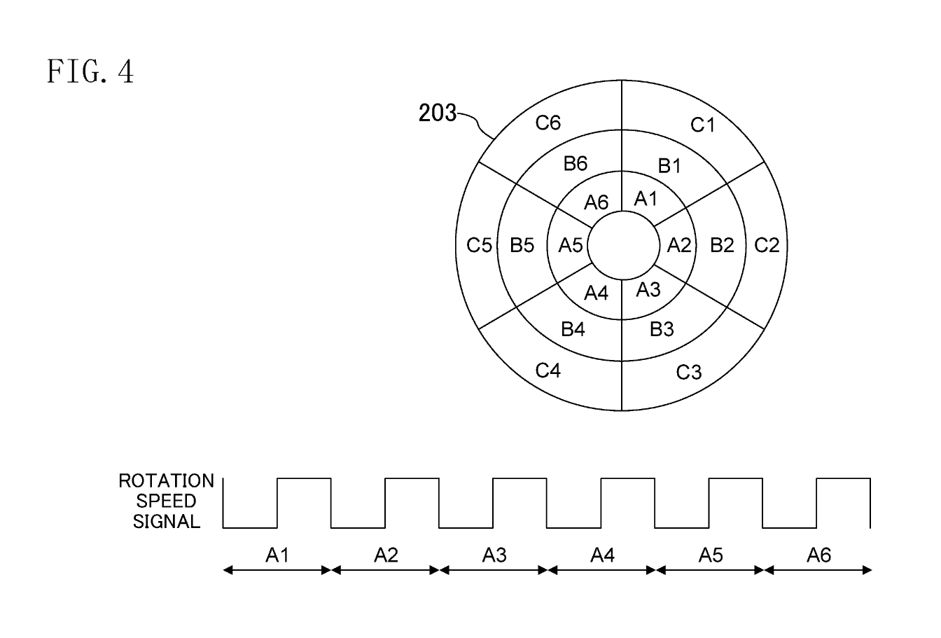

Next, an example of division of the visible image drawing area 203 is illustrated in FIG. 4. In FIG. 4, the visible image drawing area 203 is divided into 6 portions in a circumferential direction, and is divided into 3 portions in a radial direction, so that a total of 18 divided areas are formed. The radial position of each divided area is specified based on a travel distance from the innermost circumference by the rotation of the stepping motor 120, that is, a value input to the stepping motor 120.

Moreover, the position of each divided area in the circumferential direction is specified based on the rotation speed signal input to the rotating section 102 from the spindle control section 101. In FIG. 4, an example of the rotation speed signal is shown. In this example, the rotation speed signal is a pulse rising six times per rotation, and one cycle of the pulse is assigned to one divided area, so that the position of each divided area in the circumferential direction is specified. For example, when the optical disc 200 is rotated at a certain angular velocity, the irradiation position of the laser beam 111 can be specified to be in A4 at a pulse rise after three pulse rises from a pulse rise of when the irradiation position of the laser beam 111 is in A1.

Note that when the optical disc 200 is rotated at a certain angular velocity, the rotation speed signal is not limited to the pulse signal, but the positional relationship in the circumferential direction of each divided area and the predetermined position can be specified based on any signal as long as the signal indicates time elapsed since the irradiation position of the laser beam 111 was located at a predetermined position. The predetermined position may be at any position in the circumferential direction. When the rotating speed of the optical disc 200 in acquiring the reflected light amount is set to be higher than the rotating speed in forming a visible image on the label side, the acquisition time of the reflected light amount of the entirety of the optical disc 200 can be shortened.

Next, a method for determining whether or not each divided area is suitable for formation of a visible image will be described.

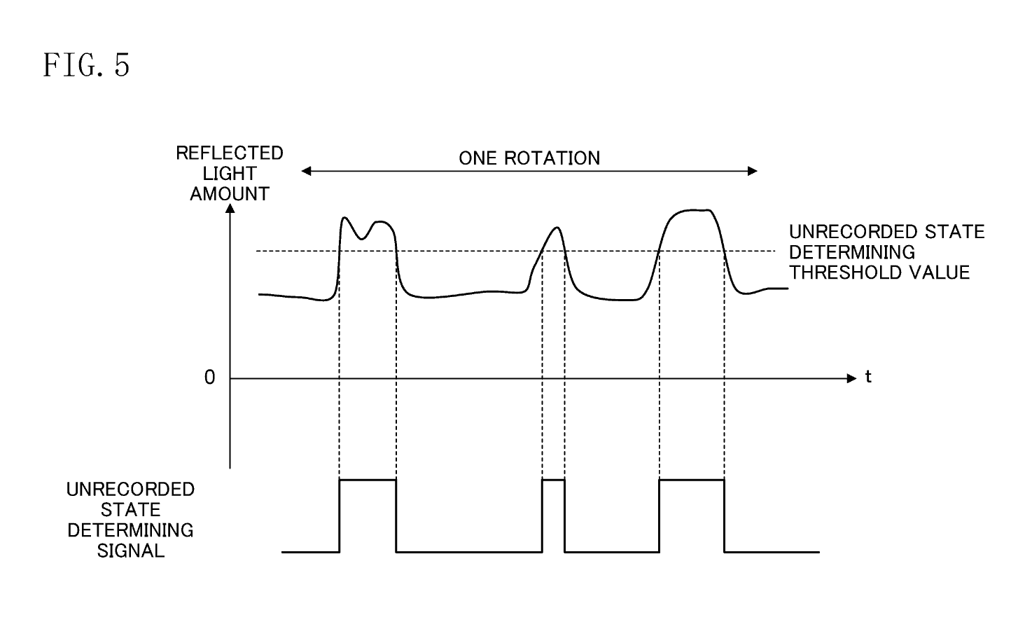

FIG. 5 illustrates an example of a reflected light amount acquired by the reflected light amount acquiring section 106 when a visible image has already been recorded in the visible image drawing area 203 of the optical disc 200. The reflected light amount of an irradiation position in the visible image drawing area 203 in which a visible image has not been recorded is equal to or less than an unrecorded state determining threshold value, whereas the reflected light amount of an irradiation position in the visible image drawing area 203 in which a visible image has been recorded is greater than the unrecorded state determining threshold value.

Therefore, the operation section 103 determines that a divided area including an irradiation position in which a reflected light amount greater than the unrecorded state determining threshold value is acquired is an area in which a visible image has already been formed, and which is not suitable for formation of a new visible image.

Note that the ratio of the number of irradiation positions in which the reflected light amount is greater than the unrecorded state determining threshold value to the number of irradiation positions in which the reflected light amount is equal to or less than the unrecorded state determining threshold value may be computed for each divided area to determine that a divided area in which the computed ratio is greater than a predetermined value is an area in which a visible image has already been formed, and which is unsuitable for formation of a new visible image.

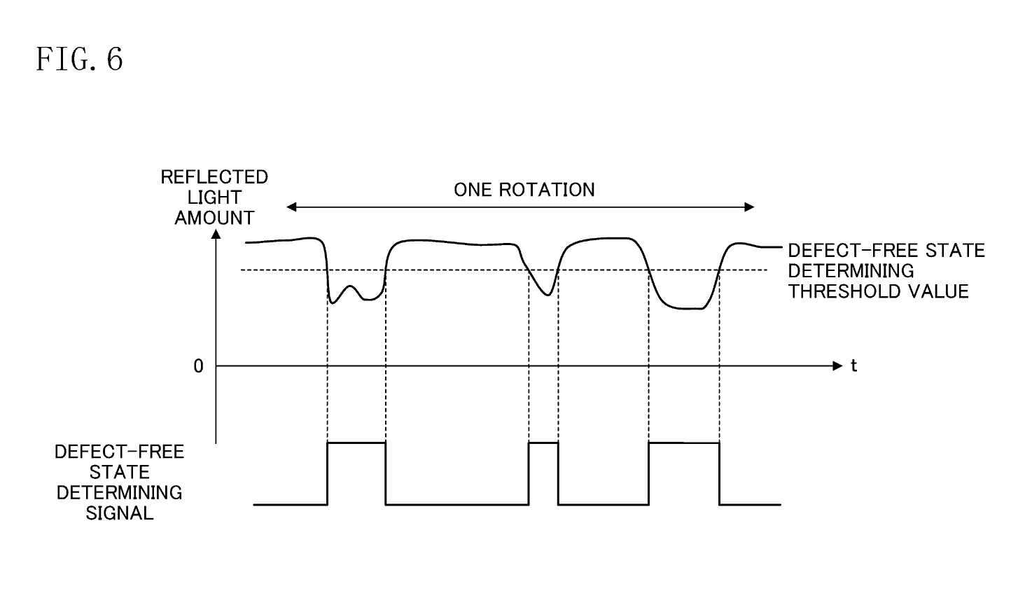

FIG. 6 illustrates an example of a reflected light amount acquired by the reflected light amount acquiring section 106 when the visible image drawing area 203 of the optical disc 200 has a defect such as a scratch. When the optical disc 200 is normal, the reflected light amount has a value which is small but is close to a certain amount in an unrecorded area. A value slightly less than the above-described value is used as a defect-free state determining threshold value to measure the reflected light amount with the optical disc 200 being rotated. In this case, in an irradiation position including no defect, the reflected light amount is equal to or greater than the defect-free state determining threshold value, and in an irradiation position including a defect, the reflected light amount is less than the defect-free state determining threshold value.

Thus, the operation section 103 determines that a divided area including an irradiation position in which a reflected light amount less than the defect-free state determining threshold value is acquired is an area including a defect and unsuitable for formation of a visible image.

Note that the ratio of the number of irradiation positions in which the reflected light amount is less than the defect-free state determining threshold value to the number of irradiation positions in which the reflected light amount is equal to or greater than the defect-free state determining threshold value may be computed for each divided area to determine that a divided area in which the ratio is greater than a predetermined value is unsuitable for formation of a visible image.

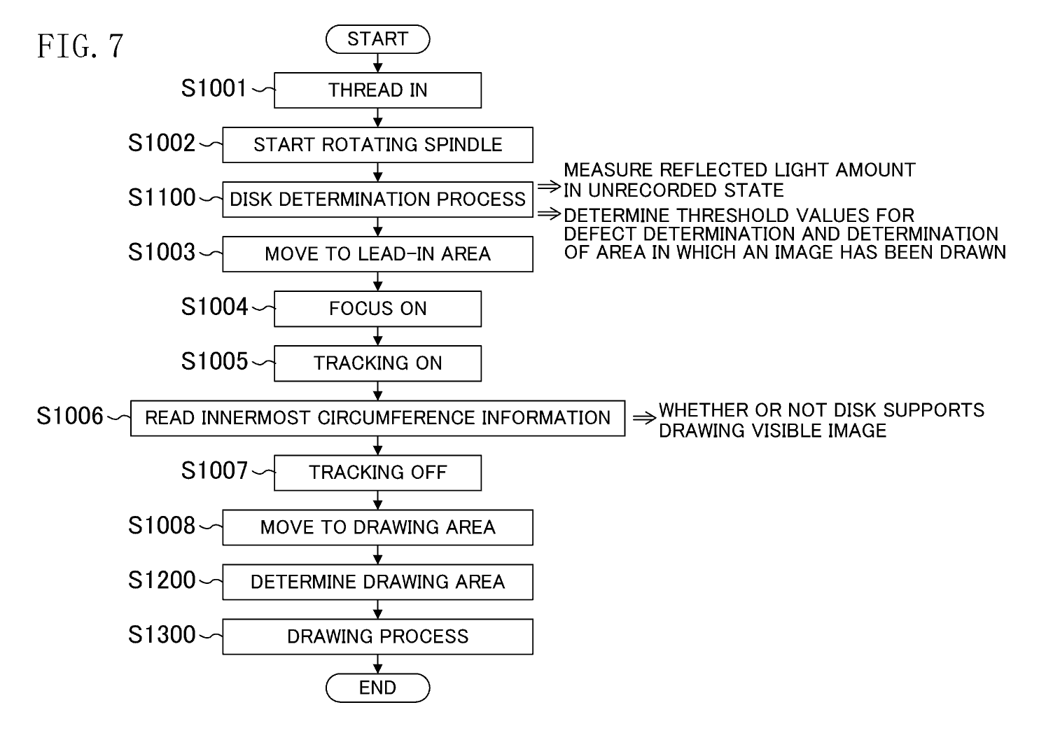

Here, operation of the optical disc recording device 100 to form a visible image will be described with reference to a flow chart of FIG. 7.

In S1001, the traverse control section 107 controls the stepping motor 120 to move the pickup section 117, thereby moving the irradiation position of the laser beam 111 to the innermost circumference of the optical disc 200. Then, the optical disc recording device 100 allows the further movement of the pickup section 117 through the control of the stepping motor 120, thereby moving the irradiation position of the laser beam 111 from the innermost circumference to the visible image drawing area 203 outside the lead-in area 201. Next, in S1002, the rotating section 102 rotates the optical disc 200. In S1100, the optical disc recording device 100 performs a later-described disk determining process. Thereafter, in S1003, the traverse control section 107 controls the stepping motor 120 to move the pickup section 117 so that the irradiation position of the laser beam 111 moves to the lead-in area 201. Next, in S1004, focus control is set to be in an on state based on the reflectivity of the lead-in area 201. In S1005, the tracking control is set to be in an on state. Then, in S1006, the optical disc recording device 100 reads the innermost circumference information recorded in the lead-in area 201, and determines, based on the innermost circumference information, whether or not the optical disc 200 is a disk supporting visible image drawing. Moreover, when the innermost circumference information indicates, for example, an optimal laser current value of the visible image drawing area 203, the value is read. Then, in S1007, the tracking control is set to be in an off state. In S1008, the traverse control section 107 controls the stepping motor 120 to move the pickup section 117 so that the irradiation position of the laser beam 111 moves to the visible image drawing area 203. Then, in S1200, the optical disc recording device 100 performs a later-described drawing area determining process. In S1300, the optical disc recording device 100 performs a later-described drawing process. During the drawing process, the focus control is in the on state, and the tracking control is in the off state. Moreover, an image is drawn by rotating the stepping motor 120 to move the pickup section 117 in the radial direction of the optical disc 200. When the drawing process is completed, the process of FIG. 7 ends.

Note that after completing the drawing process in S1300, the drawing area determining process in S1200 may be performed again to determine whether or not the image has been recorded.

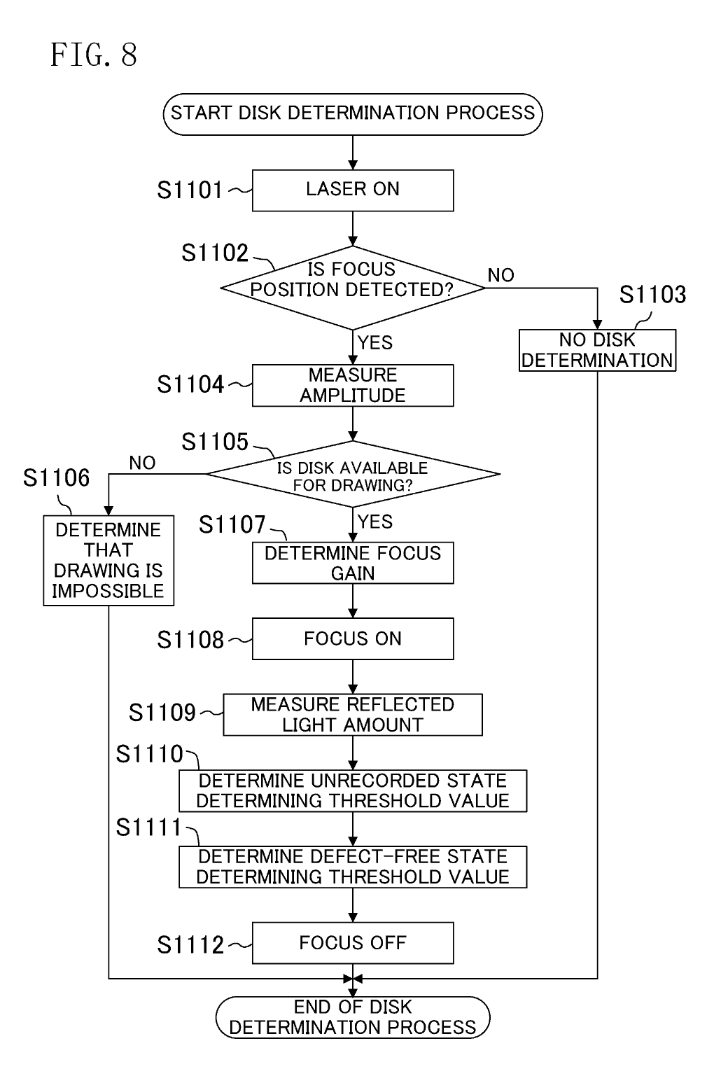

FIG. 8 is a flow chart illustrating the disk determining process in S1100 of FIG. 7.

First, in S1101, the laser 108 is set to be in an on state. Then, the process proceeds to S1102.

In 1102, the focus control section 105 allows the focus actuator 114 to travel up and down to search a position of the focus actuator 114 in which the laser beam 111 is focused on the optical disc 200. When a position in which the wave form of the focus error signal forms an S shape in the vicinity of a focusing point is detected, the process proceeds to S1104. When the position in which the wave form of the focus error signal forms the S shape in the vicinity of the focusing point cannot be detected, the process proceeds to S1103.

In S1103, the optical disc recording device 100 performs a NO DISC determination, and the disk determining process ends.

By contrast, in S1104, the operation section 103 measures the amplitude of the focus error signal. Then, the process proceeds to S1105.

In S1105, the operation section 103 compares the amplitude measured in S1104 with a predetermined value. When the amplitude is larger than the predetermined value, the operation section 103 determines that the irradiation position of the laser beam 111 is not in the color changeable layer, and so drawing an image is impossible, and the process proceeds to S1106. By contrast, if the amplitude is equal to or less than the predetermined value, the operation section 103 determines that drawing an image is possible, and the process proceeds to S1107.

In S1106, the optical disc recording device 100 ends the disk determining process.

In S1107, the operation section 103 determines the gain of the focus control based on the amplitude of the focus error signal. Then, the process proceeds to S1108.

In S1108, the focus control is set to be in the on state. Then, the process proceeds to S1109.

In S1109, the reflected light amount acquiring section 106 acquires a reflected light amount in the on state of the focus control. Then, the process proceeds to S1110.

In S1110, the operation section 103 adds a predetermined value to the reflected light amount acquired in S1109 or multiplies the reflected light amount acquired in S1109 by the predetermined value to compute a value greater than the reflected light amount (e.g., a value 1.2 times as large as the acquired reflected light amount) as an unrecorded state determining threshold value. Then, the process proceeds to S1111.

In S1111, the operation section 103 subtracts a predetermined value from the reflected light amount acquired in S1109, or divides the reflected light amount acquired in S1109 by the predetermined value to compute a value less than the reflected light amount (e.g., a value 0.8 times as large as the acquired reflected light amount) as the defect-free state determining threshold value. Then, the process proceeds to S1112.

In S1112, the focus control is set to be in the off state, and the disk determining process ends.

In the present embodiment, the unrecorded state determining threshold value is computed based on the reflected light amount outside the lead-in area 201. However, when the reflectivity in the unrecorded area of the lead-in area 201 is the same as the reflectivity of the visible image drawing area 203, the unrecorded state determining threshold value may be computed based on the reflected light amount of the lead-in area 201. This can ensure acquisition of the reflected light amount and computation of the unrecorded state determining threshold value because the lead-in area 201 necessarily has the unrecorded area. Alternatively, the entirety of the disk determining process in S1100 may be performed with the lead-in area 201 being irradiated with the laser beam 111. In this way, it becomes unnecessary to perform the process of moving the pickup section 117 in S1003. Thus, the processing time can be reduced.

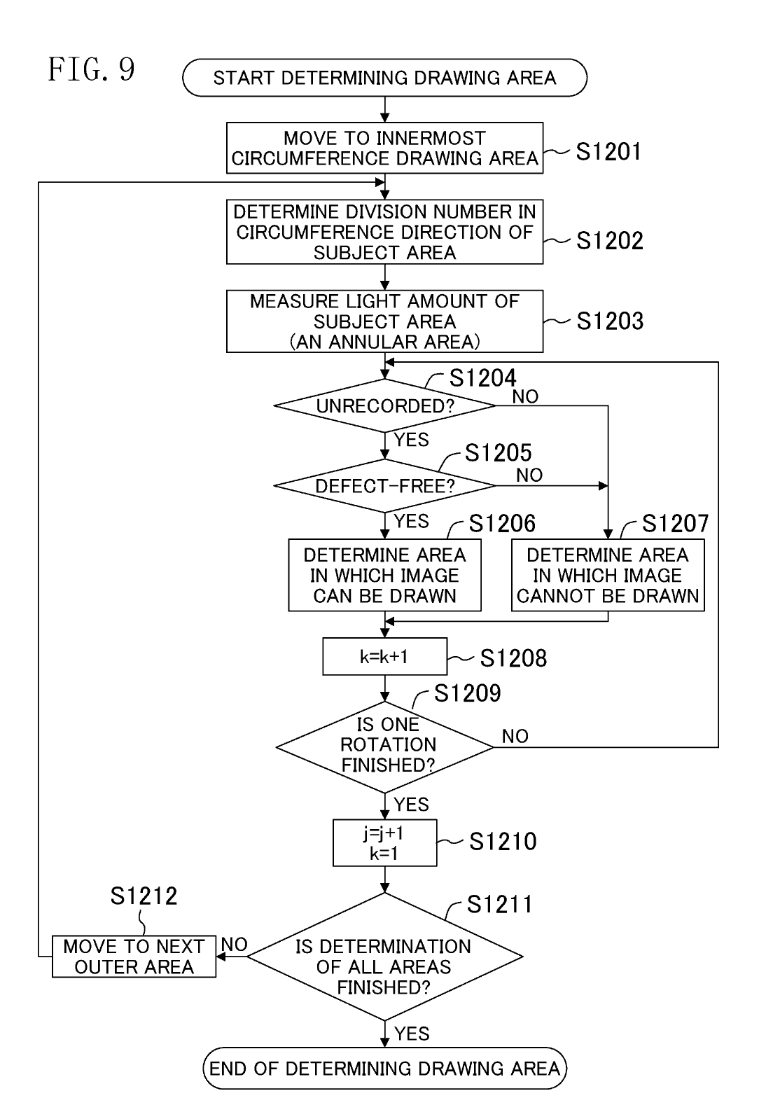

FIG. 9 is a flow chart illustrating the drawing area determining process in S1200 of FIG. 7. The visible image drawing area 203 is divided, for example, into the divided areas described with reference to FIG. 4. It is provided that circumferential direction area numbers which are incremented by 1 starting from 1 are assigned to the divided areas, and radial direction area numbers which are incremented by 1 starting from 1 at the inner circumference are assigned to the divided areas.

First, in S1201, the traverse control section 107 controls the stepping motor 120 to move the pickup section 117 so that the irradiation position of the laser beam 111 moves to an innermost circumference of the visible image drawing area 203. Then, the process proceeds to S1202. Here, it is provided that the visible image drawing area 203 is divided into m annular areas in the radial direction. The innermost circumference of the visible image drawing area 203 is an innermost portion of an annular area to which a radial direction area number 1 is assigned (area composed of areas A1-A6 of FIG. 4). Moreover, j=1.

In S1202, the operation section 103 determines the division number n in the circumferential direction of the annular area to which the radial direction area number j is assigned. Then, the process proceeds to S1203. The determination is made based on an externally given instruction for division. In the example of FIG. 4, three annular areas A1-A6, B1-B6, and C1-C6 are each divided into six areas, and thus the division number n is six. When the process in S1202 is performed after the process in S1201, the process in S1202 is to determine the division number for the annular area at the innermost circumference of the visible image drawing area 203. However, when the process in S1202 is performed after a process in S1212 which will be described later, the process in S1202 is to determine the division number for annular areas except for the annular area at the innermost circumference.

Note that in the example of FIG. 4, the division number for each annular area is six so that the areas A1-A6, B1-B6, and C1-C6 are obtained, but division numbers for the annular areas may differ from each other.

In S1203, the reflected light amount acquiring section 106 acquires the reflected light amounts from a plurality of irradiation positions included in the annular area to which the radial direction area number j is assigned. Here, the reflected light amounts are measured with the optical disc 200 being rotated. Thus, even when the annular area is divided into a plurality of divided areas, the reflected light amounts at the irradiation positions included in the plurality of divided areas can be successively measured during one rotation of the optical disc 200, and thus the efficiency of measurement is high. Here, it is provided that k=1.

Specifically, the reflected light amounts are acquired with the optical disc 200 being rotated, where during one rotation of the optical disc 200, the tracking actuator 115 moves the irradiation position of the laser beam 111 by d1 inward and outward and by d2 inward and outward from a radial position in a state where a voltage is not applied to the tracking actuator 115 (hereinafter referred to as a “reference radial position”). At each rotation of the optical disc 200, the traverse control section 107 moves the pickup section 117 to move the reference radial position by the sum of d1 and d2 which are widths by which the pickup section 117 can move inward and outward. That is, the optical disc recording device 100 repeats, a plurality of times, one-rotation reflected light amount acquisition operation in which the reflected light amounts are acquired from the plurality of irradiation positions by the reflected light amount acquiring section 106 during one rotation of the optical disc 200 while moving the reference radial position by the sum of d1 and d2 every time the one-rotation reflected light amount acquisition operation is completed. The acquired result is recorded in, for example, a recording means, and the process proceeds to S1204.

In S1204, the operation section 103 compares the unrecorded state determining threshold value computed in the disk determining process in S1100 with the reflected light amount acquired in S1203 from each irradiation position included in the divided area to which a circumferential direction area number k is assigned. When an irradiation position in which the reflected light amount is greater than the unrecorded state determining threshold value exists, the divided area to which the circumferential direction area number k is assigned is determined to be a recorded area, and the process proceeds to S1207. By contrast, when an irradiation position in which the reflected light amount is greater than the unrecorded state determining threshold value does not exists, the divided area to which the circumferential direction area number k is assigned is determined to be an unrecorded area, and the process proceeds to S1205.

Note that in S1204, the operation section 103 may compute the ratio of the number of irradiation positions in which the reflected light amounts are greater than the unrecorded state determining threshold value to the number of irradiation positions in which the reflected light amounts are equal to or less than the unrecorded state determining threshold value. In this case, when the value of the ratio is greater than a predetermined value, it may be determined that the area is a recorded area. When the value of the ratio is less than the predetermined value, it may be determined that the area is an unrecorded area.

In S1205, the operation section 103 compares the defect-free state determining threshold value computed in the disk determining process in S1100 with the reflected light amount measured in S1203 for each irradiation position included in the divided area to which the circumferential direction area number k is assigned. When an irradiation position in which the reflected light amount is less than the defect-free state determining threshold value exists, the divided area to which the circumferential direction area number k is assigned is determined to have a defect, and the process proceeds to S1207. By contrast, when an irradiation position in which the reflected light amount is less than the defect-free state determining threshold value does not exist, the divided area to which the circumferential direction area number k is assigned is determined to have no defect, and the process proceeds to S1206.

Note that in S1205, the operation section 103 may compute the ratio of the number of irradiation positions in which reflected light amounts are less than the defect-free state determining threshold value to the number of irradiation positions in which the reflected light amounts are equal to or greater than the defect-free state determining threshold value. In this case, when the value of the ratio is greater than a predetermined value, it may be determined that the area has a defect. When the value of the ratio is less than the predetermined value, it may be determined that the area has no defect.

In S1206, the operation section 103 determines that the divided area to which the circumferential direction area number k is assigned is an area which is suitable for formation of a visible image and is available for drawing an image. Then, the process proceeds to S1208.

In S1207, the operation section 103 determines that the divided area to which the circumferential direction area number k is assigned is an area which is unsuitable for formation of a visible image and is unavailable for drawing an image. Then, the process proceeds to S1208.

In S1208, the operation section 103 adds 1 to k. Then, the process proceeds to S1209.

In S1209, the operation section 103 compares k with the division number n. When k is equal to or less than the division number n, it is determined that the determination for the divided area of one rotation is not ended, and the process proceeds to S1204. When k=division number n+1, it is determined that the determination for the divided area of one rotation is ended, and the process proceeds to S1210.

In S1210, the operation section 103 adds 1 to j, and it is provided that k=1. Then, the process proceeds to S1211.

In S1211, when j is the radial direction division number m+1, the operation section 103 determines that the determination for all the annular areas is ended, and ends the image drawing area determination. By contrast, when j is equal to or less than the radial direction division number m, the process proceeds to S1202.

In S1212, the optical disc recording device 100 moves the irradiation position of the laser beam 111 to a jth annular area from the inner side of the optical disc 200. Then, the process proceeds to S1202. Here, when an outermost portion of a (j-1)th annular area from the inner side is in contact with the jth annular area, a continuous visible image and a continuous defect which extend over a plurality of annular areas can be recognized.

Note that the processes of S1204-S1209 may not be continuously performed n times (where n is the division number in the circumferential direction), but the determinations in S1204 for n divided areas may be made simultaneously, the determinations in S1205 for n divided areas may be made simultaneously, and the processes in S1208 and S1209 may be omitted.

Moreover, the threshold value comparison may not performed in S1204 and S1205 after recording the measurement result in the recording means in S1203, but each threshold value may be compared with the measurement result immediately after the acquisition of the measurement result, and the comparison result may be recorded in the recording means. In this case, only a comparison result which is smaller in capacity than the measurement result may be recorded in the recording means, which can reduce the area used for the recording means.

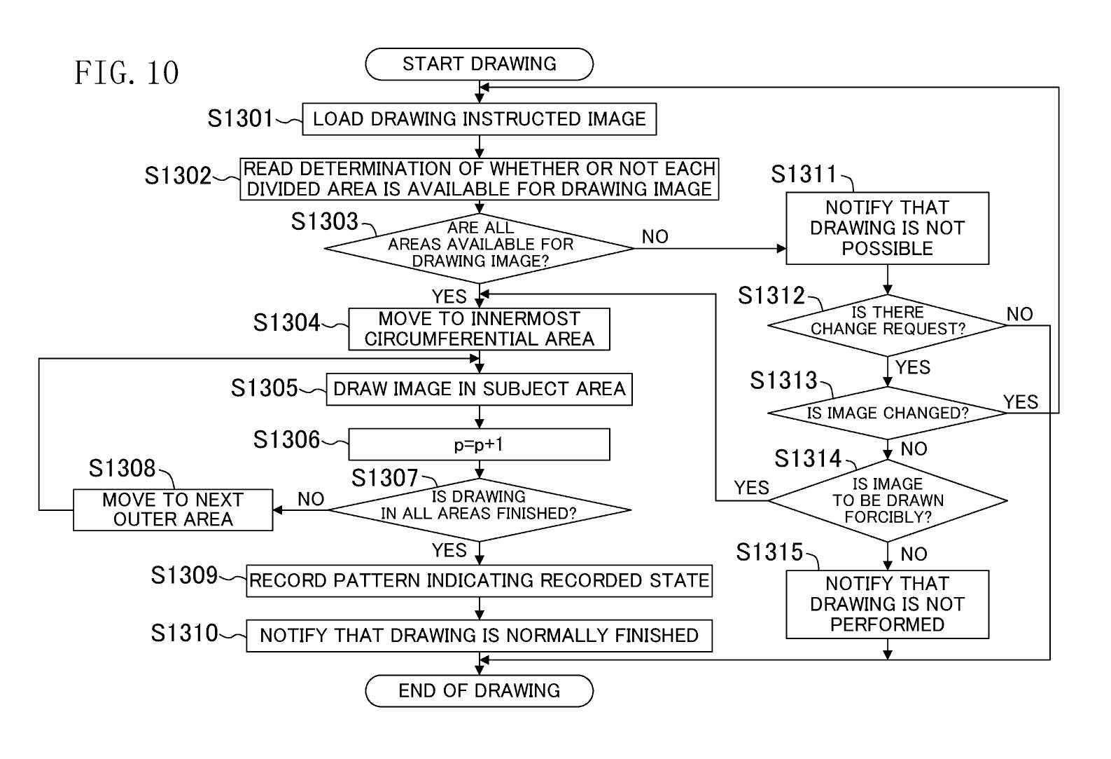

FIG. 10 is a flow chart illustrating the drawing process in S1300 of FIG. 7.

First, in S1301, a drawing instructed image which the optical disc recording device 100 will draw is loaded from a host personal computer. Then, the process proceeds to S1302.

In S1302, the operation section 103 reads whether or not each divided area is determined to be an area available for drawing the image in the drawing area determining process of S1200. Then, the process proceeds to S1303.

In S1303, the operation section 103 determines, based on the determination result read in S1302 for each divided area, whether or not the entirety of the drawing instructed image loaded in S1301 can be drawn. If it is possible to draw the entirety of the drawing instructed image, the process proceeds to S1304. If it is not possible to draw part or the entirety of the drawing instructed image, the process proceeds to S1312. For example, all the area, that is, all the divided areas are available for drawing the image, the process proceeds to S1304. Even when some divided areas are not available for drawing the image, the process proceeds to S1304 if the divided areas are areas in which the drawing instructed image loaded in S1301 is not to be drawn.

In S1304, the traverse control section 107 moves the pickup section 117 through the rotation of the stepping motor 120, thereby moving the irradiation position of the laser beam 111 to the innermost circumference of the divided area which is located at the innermost circumference and in which the image is to be drawn. Then, the process proceeds to S1305. Here, it is provided that p=1.

In S1305, the optical disc recording device 100 forms a visible image in a divided area of a pth annular area from the inner side among a plurality of annular areas obtained by dividing the visible image drawing area 203 by m in the radial direction, where the divided area is determined to be an area available for drawing a picture in the drawing area determining process in S1200 and has the drawing instructed image, whereas the optical disc recording device 100 does not form the visible image in other divided areas. Next, the process proceeds to S1306.

In S1306, 1 is added to p. Then, the process proceeds to S1307.

In S1307, the operation section 103 compares p with the radial direction division number m. When p is equal to or less than m, the operation section 103 determines that the formation of the visible image in all the annular areas is not ended, and the process proceeds to S1308. When p is m+1, the operation section 103 determines that the formation of the visible image in all of the annular areas is ended, and the process proceeds to S1309.

In S1308, the traverse control section 107 moves the irradiation position of the laser beam 111 to the pth annular area from the inner side. Then, the process proceeds to S1305. Here, if an outermost portion of a (p-1)th annular area from the inner side is in contact with the pth annular area, a continuous image extending over the plurality of annular areas can be formed.

In S1309, the optical disc recording device 100 records a pattern in the area 202 of FIG. 3 for each divided area in which the visible image is formed, where the pattern indicates that the visible image has been drawn in the divided area. Then, the process proceeds to S1310. Checking the pattern makes it possible to determine whether or not the image has been drawn without performing the disk determining process in S1100 of FIG. 7. That is, the optical disc recording device 100 is configured so that a visible image is not formed in the divided area for which the pattern indicates that the image has been drawn, thereby reducing time for the disk determining process.

In S1310, the optical disc recording device 100 notifies the end of the drawing process to the host personal computer to end the drawing process.

In S1311, the optical disc recording device 100 notifies to the host personal computer that the drawing instructed image overlaps an area which has a recorded image or a defect. Then, the process proceeds to S1312.

In S1312, the optical disc recording device 100 waits for a change request for the drawing instructed image for an independently set period. When the optical disc recording device 100 receives the change request from the host personal computer, the process proceeds to S1313. When the optical disc recording device 100 does not receive the change request after the independently set period has elapsed, the drawing process ends.

In S1313, the optical disc recording device 100 compares an image after the change with the drawing instructed image originally loaded in S1301. When there is a change, the process proceeds to S1301, but when there is no change, the process proceeds to S1314.

In S1314, the optical disc recording device 100 determines whether or not the drawing instructed image overlapping the area having a recorded image or a defect is forcibly formed. When the optical disc recording device 100 receives, from the host personal computer, an instruction that the image is to be forcibly formed, the process proceeds to S1304, but otherwise, the process proceeds to S1315. In S1315, the optical disc recording device 100 notifies, to the host personal computer, that drawing the image is not performed to end the drawing process.

According to the present embodiment, a visible image is not formed in a divided area including an irradiation position in which a reflected light amount greater than the unrecorded state determining threshold value is acquired. This prevents destruction of a visible image which has already been formed. Moreover, a visible image is not formed in a divided area including an irradiation position in which the reflected light amount less than the defect-free state determining threshold value is acquired, so that the visible image which is to be formed does not overlap a defect such as a scratch. This can ensure formation of a highly visible image.

Note that in the present embodiment, the host personal computer sends the drawing instructed image to the optical disc recording device 100, and the optical disc recording device 100 determines, based on the determination result in the drawing area determining process in S1200, whether or not the entirety of the drawing instructed image can be drawn. However, the optical disc recording device 100 may send the determination result in the drawing area determining process in S1200 to the host personal computer, and the host personal computer may generate a visible image which does not overlap an area in which the image cannot be drawn as the drawing instructed image, and send the drawing instructed image to the optical disc recording device 100.

Moreover, in the present embodiment, the visible image drawing area 203 is divided into a plurality of divided areas, and it is determined whether or not each of divided areas is suitable for formation of a visible image. However, it may be determined whether or not the entirety of the visible image drawing area 203 is suitable for the formation of the visible image without dividing the visible image drawing area 203.

Although the visible image drawing area 203 in the present embodiment is divided both in the radial direction and in the circumferential direction, the visible image drawing area 203 may be divided in any one of the directions.

Although the above determination for each divided area is made based on the reflected light amounts of the plurality of irradiation positions in the present embodiment, the determination may be made based on the reflected light amount of one irradiation position.

Although the optical disc recording device 100 in the present embodiment is connected to the host personal computer, the optical disc recording device 100 may be connected to a controlling microcomputer instead of the host personal computer, and the controlling microcomputer may serve as the host personal computer.

The optical disc recording device and the method for drawing an image on an optical disc according to the present invention have the advantage that destruction of already formed visible image and formation of less visible image can be prevented, and are useful as a technique in which a color changeable layer which is formed on a label side of an optical disc and changes in color due to heat or light is irradiated with a laser beam to form a visible image on the label side.

What is claimed is:

1. An optical disc recording device configured to irradiate a color changeable layer which is formed on a label side of an optical disc and changes in color due to heat or light with a laser beam to form a visible image in a visible image drawing area of the label side, the optical disc recording device comprising:
a reflected light amount acquiring section configured to acquire a reflected light amount of the laser beam with which the color changeable layer is irradiated; and
an operation section configured to compare the reflected light amount acquired from at least one irradiation position in a predetermined drawing determination area of the visible image drawing area by the reflected light amount acquiring section with a predetermined threshold value to determine whether or not the drawing determination area is suitable for formation of the visible image, wherein
the visible image is not formed in the drawing determination area when the operation section determines that the drawing determination area is unsuitable for the formation of the visible image.

2. The optical disc recording device of claim 1, wherein
the operation section determines that the drawing determination area is unsuitable for the formation of the visible image when a reflected light amount larger than the predetermined threshold value is acquired from the at least one irradiation position.

3. The optical disc recording device of claim 1, wherein
the operation section determines that the drawing determination area is unsuitable for the formation of the visible image when a reflected light amount less than the predetermined threshold value is acquired from the at least one irradiation position.

4. The optical disc recording device of claim 1, wherein
the operation section divides the visible image drawing area into a plurality of divided areas, and specifies each divided area as the drawing determination area.

5. The optical disc recording device of claim 4, wherein
the divided areas are areas obtained by dividing the visible image drawing area at least in a radial direction of the optical disc.

6. The optical disc recording device of claim 4, wherein
the optical disc is rotated at a certain angular velocity when each divided area is specified by the operation section,
the divided areas are areas obtained by dividing the visible image drawing area at least in a circumferential direction of the optical disc, and
the operation section specifies, based on a signal indicating time elapsed since the irradiation position of the laser beam was located in a predetermined position, a positional relationship between each divided area and the predetermined position in the circumferential direction.

7. The optical disc recording device of claim 4, wherein
every time drawing the visible image in each drawing determination area is completed, a pattern indicating that the visible image has been drawn in each drawing determination area is written in a certain part of the label side, and
a visible image is not formed in the drawing determination area for which the pattern written in the certain part indicates that the visible image has been drawn.

8. The optical disc recording device of claim 1, further comprising:
a tracking actuator configured to move the irradiation position of the laser beam in a radial direction of the optical disc, wherein
one-rotation reflected light amount acquisition operation, where reflected light amounts are acquired from multiple ones of the irradiation position by the reflected light amount acquiring section during one rotation of the optical disc with the irradiation position of the laser beam being moved by the tracking actuator by widths by which the tracking actuator can move inward and outward from a predetermined reference radial position, is repeated a plurality of times while moving the reference radial position by a sum of the inward and outward widths by which the tracking actuator can move every time the one-rotation reflected light amount acquisition operation is completed.

9. A method for drawing an image on an optical disc by irradiating a color changeable layer which is formed on a label side of an optical disc and changes in color due to heat or light with a laser beam to form a visible image in a visible image drawing area of the label side, the method comprising:
a reflected light amount acquiring step of acquiring a reflected light amount of the laser beam with which at least one irradiation position in a predetermined drawing determination area of the visible image drawing area is irradiated; and
an operation step of comparing the reflected light amount acquired from the at least one irradiation position in the reflected light amount acquiring step with a predetermined threshold value to determine whether or not the drawing determination area is suitable for formation of the visible image, wherein
the visible image is not formed in the drawing determination area when the operation step determines that the drawing determination area is unsuitable for the formation of the visible image.

10. The method of claim 9, wherein
the operation step determines that the drawing determination area is unsuitable for the formation of the visible image when a reflected light amount larger than the predetermined threshold value is acquired from the at least one irradiation position.

11. The method of claim 9, wherein
the operation step determines that the drawing determination area is unsuitable for the formation of the visible image when a reflected light amount less than the predetermined threshold value is acquired from the at least one irradiation position.

12. The method of claim 9, wherein
the operation step divides the visible image drawing area into a plurality of divided areas, and specifies each divided area as the drawing determination area.

13. The method of claim 12, wherein
the divided areas are areas obtained by dividing the visible image drawing area at least in a radial direction of the optical disc.

14. The method of claim 12, wherein
the optical disc is rotated at a certain angular velocity when each divided area is specified by the operation step,
the divided areas are areas obtained by dividing the visible image drawing area at least in a circumferential direction of the optical disc, and
the operation step specifies, based on a signal indicating time elapsed since the irradiation position of the laser beam was located in a predetermined position, a positional relationship between each divided area and the predetermined position in the circumferential direction.

15. The method of claim 12, wherein
every time drawing the visible image in each drawing determination area is completed, a pattern indicating that the visible image has been drawn in each drawing determination area is written in a certain part of the label side, and
a visible image is not formed in the drawing determination area for which the pattern written in the certain part indicates that the visible image has been drawn.

16. The method of claim 9, wherein
one-rotation reflected light amount acquisition step, where the reflected light amount acquiring step is repeated for multiple ones of the irradiation position during one rotation of the optical disc with the irradiation position of the laser beam being moved by widths by which the tracking actuator can move inward and outward from a predetermined reference radial position, is repeated a plurality of times while moving the reference radial position by a sum of the inward and outward widths by which the tracking actuator can move every time the one-rotation reflected light amount acquisition operation is completed.
